(19) United States
(12) Patent Application Publication
(10) Pub. No.: US 2007/0065782 A1
(43) Pub. Date: Mar. 22, 2007

(54) Dental examination and treatment tool

(76) Inventor: Michael Maschke, Lonnerstadt (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/523,365

(22) Filed: Sep. 19, 2006

(30) Foreign Application Priority Data
Sep. 20, 2005 (DE) 10 2005 044 889.5

(51) Int. Cl. A61C 5/02

(52) U.S. Cl. 433/224

(57) ABSTRACT

The invention relates to a Dental examination or treatment tool. the tool comprises at least one lumen in which at least one imaging catheter is or can be accommodated for recording image data of an examination or treatment area.

### CROSS REFERENCE TO RELATED APPLICATIONS

This application claims priority of German application No. 10 2005 044 889.5 filed Sep. 20, 2005, which is incorporated by reference herein in its entirety.

### FIELD OF THE INVENTION

The invention relates to a dental examination or treatment tool and to an associated method.

### BACKGROUND OF THE INVENTION

Dental treatments such as, for example, a root treatment, in which the pulp of the tooth is removed and the root canal then cleaned and sealed, have to be carried out carefully so that infections and further complications can be excluded if possible. If, for example, infected pulp is not completely removed, not only can this lead to pain and swelling, but infections can also spread to the jaw bones. In such a case, the tooth concerned has then to be removed and subsequent harm can arise for the patient if, for example, the infection not only affects the jaw bones but also spreads to further organs.

More complicated dental treatments often entail multiple visits to the dentist. In order to monitor the treatment, the treatment flow is interrupted in order to prepare, in a separate X-ray room, X-ray photographs of the tooth or of its roots or of a surrounding area. Such an X-ray method is not easy to implement since, in order to carry it out, the patient has to hold the films in his/her mouth. Moreover, a certain time is required for developing the X-ray photographs.

The X-ray photographs, which are as a rule two-dimensional, provide only a limited overview of, for example, a cleaned root canal or the associated filling. Further real images of the progress of the treatment or of the success of cleaning of the root canals or such like are not available. However, where cleaning is unsatisfactory, for example cysts can occur in the jaw bone which can lead to softening of the bone and can also be a trigger for further disorders such as, for example, an inflammation of the heart valve.

### SUMMARY OF THE INVENTION

The object of the invention is thus to establish a remedy for these problems.

In order to achieve this object, a dental examination and/or treatment tool is provided which comprises at least one lumen in which at least one imaging catheter is or can be accommodated for recording image data of an examination and/or treatment area.

So, according to the invention, a dental drill or another dental tool, for example for cleaning a root canal, is equipped with an imaging catheter which is accommodated in a corresponding aperture of the tool or can be introduced into this aperture. The imaging catheter is positioned such that the examination and/or treatment area can be represented on a display or monitor with the aid of the image data from the catheter. It is thus possible to record and display image data repeatedly during the examination and/or treatment. The recording of image data can under certain circumstances even be carried out continuously.

Where suitable techniques are used for image recording, then even three-dimensional images can in this way be obtained throughout the examination process without treatment having to be interrupted, as was previously the case with X-ray monitoring, in order for the patient to go to an X-ray room provided specifically for that purpose. The dentist consequently has an effective monitoring facility for the treatment available to him/her throughout the treatment or optionally in real time, after a brief triggering of the imaging functionality by the correspondingly fashioned inventive dental examination and/or treatment tool. The dental examination and/or treatment tool can be used here for a root treatment, for implants or in the field of orthodontics and other dental fields in which image monitoring is appropriate or necessary.

The imaging catheter can be a catheter for optical coherence tomography and/or an ultrasound-based and/or magnetic resonance-based catheter. Thus, for example an OCT catheter (optical coherence tomography catheter) is arranged in the lumen of the tool for recording. The production of image recordings in a three-dimensional system of coordinates is thus possible, using a position sensor system at the tip of the tool. Alternatively or additionally, an ultrasound-based or magnetic resonance-based catheter can be used, based for example on intravascular ultrasound (IVUS) and intravascular magnetic resonance imaging (IVMRI) techniques. For this purpose, the imaging catheter can be fashioned with suitable combination sensors, for example with a sensor system combining OCT and IVUS or IVMRI and IVUS. In this way, during a root treatment or another dental examination and treatment, the doctor can obtain comprehensive image information throughout in order to improve the quality and the outcome of the treatment. Furthermore, the total treatment time needed can advantageously be reduced for the patient.

According to the invention, the tool can consist at least in part of a material which is transparent for an imaging signal of the imaging catheter and/or have an aperture which is transparent for the imaging signal. For example, it is possible for a drill for drilling a tooth to be equipped with an imaging catheter, a window for the emergence of the imaging signal of the imaging catheter being provided in the area of the tip close to the actual treatment unit. The light of the OCT catheter or the ultrasound signal of an IVUS catheter, for example, can emerge through this window. For imaging in different areas or over a longer section, the tool can be constructed over its entire length or over at least a considerable subsection from such a transparent material. By way of example, mention should be made here of a carbon-fiber material through which the imaging catheter, moved in the lumen, can emit signals into the treatment area and through which it records the image signals in order to route these for further processing.

The imaging catheter and/or the lumen can be movable via a motor unit. Thus, the tool usefully has, in its end area or in the area of a tool console of a treatment room, a connection to a motor unit to be assigned to the tool or provided in a console which makes it possible for the imaging catheter or the lumen to be moved. In this way, for example, an OCT sensor which is fashioned as a revolving mirror or rotating glass-fiber line can be rotated or else a lumen or the imaging catheter can be displaced forwards or backwards in a longitudinal direction relative to the tool.

A signal interface can serve to control the one or more imaging sensors or to forward the control signals for the drive and to route for further processing the recorded image signals or other signals which are recorded or produced in the area of the tool.

In addition, a handpiece can be provided which comprises at least one actuating element for operating the imaging catheter. The medical treatment tool thus usefully has a suitable handle which enables the dentist or a dental assistant to operate it. This handle or the handpiece can be fitted with one or more actuating elements in order, for example, to start, terminate or change the speed of the rotation of the revolving mirror in an OCT catheter or to enable the forward or backward displacement of the imaging catheter for imaging in different sections of the treatment area. Switches and/or pushbuttons or displaceable actuating elements, rotary knobs and the like can be provided for this purpose. The actuating elements can be arranged here on different sides of the handle or handpiece, an ergonomic arrangement being preferable in order to maximize ease of operability.

An actuating element of the handpiece can be provided for displacing the lumen and/or for displacing the imaging catheter along the handpiece and/or for starting and/or terminating a rotational movement of at least one part of the imaging catheter and/or for adjusting a rotational speed and/or displacement speed of the imaging catheter and/or of the lumen. For example, it is possible for a rotational movement of a sensor area or of the imaging catheter to be triggered with the aid of a switch; likewise, a displacement of the imaging catheter in the tool, optionally indirectly via a displacement of the lumen in the tool, can be achieved automatically, e.g. via a motor unit. It is alternatively or additionally conceivable for the imaging catheter or the sensor to be displaced manually via mechanical elements, for example, by means of a coupling to corresponding rotary knobs or the like. Thus, the imaging can be optimally controlled via the handpiece, which is in any case generally required in order to operate a dental treatment tool. It is particularly useful if the movement of the lumen or of the imaging catheter occurs at a defined speed or in defined and known steps so that, taking these parameters into account, the recorded signals flow into as fault-free as possible a representation of the examination and treatment area on a display.

Of course, as an alternative to the actuating elements integrated in the handpiece, separate actuating elements can be provided in the area of the handpiece or else in the area of a console for connecting dental tools, for example pushbuttons on a console for activating a rotation or the like. This can be especially useful where the integration of actuating elements in the handpiece is rendered difficult by operating elements already provided on the handpiece, for example for a drill function or such like, so that incorrect operations cannot be ruled out.

According to the invention, a position sensor system can be provided for determining the two-dimensional and/or three-dimensional position of at least a part, in particular a tip, of the imaging catheter in the examination and/or treatment area. The position sensor system is preferably a system with an electromagnetic operating principle. Alternatively, electrical, acoustic, optical or capacitive and other position sensor systems can be used. The combination with such a position sensor system, which is fashioned electromagnetically for example, enables representation of the dental tool, in particular of the tip, for example in a three-dimensional coordinate system, together with the image data of an OCT sensor. In this way, the dentist obtains, for example on his/her TFT display, a three-dimensional representation of the treatment area with a representation of the tip of the dental tool. This improves orientation and enables a more accurate treatment procedure.

The tool can comprise a control and/or processing device for controlling imaging signals and/or for processing recorded image data. This device generates the appropriate imaging signals or forwards these via the signal lines to the imaging sensors of the imaging catheter. Furthermore, processing of the recorded image data for suitable display on a monitor or for filing in a storage device, for example for subsequent analysis for carrying out follow-up treatments, usefully takes place in the control and/or processing device. The control and/or processing device is usefully detachably connected with the other components of the tool in order, when a handpiece or the treatment part is being cleaned, to protect the electronic components of the control and/or processing device against damaging effects.

Alternatively, it is possible for the control and/or processing device to be fashioned fully or at least in part as a component separate from the tool, for example as a component of an operator console, it being optionally possible in each case for the control and/or processing device to be fashioned for controlling further dental tools with their respective imaging systems. At the same time, it is also conceivable for an imaging catheter to be used with different dental tools by being introduced in each case into a corresponding lumen of the tool.

The control and/or processing device can be fashioned for image recording and/or image display essentially in real time and/or for the three-dimensional reconstruction of recorded image data and/or for the merger of image data from various imaging equipment.

If the images are displayed almost in real time on a monitor or display, this enables continuous tracking of the treatment and examination carried out, by means of which the quality can be significantly improved, since the previously unavoidable “blind” implementation of individual method steps no longer applies. Interruption of the treatment in order to produce separate monitoring recordings is no longer necessary. In any case, the patient does not have to leave the treatment room and go to a separate room for the production of X-ray photographs. If the recorded image data is displayed three-dimensionally, this enables optimum orientation in the examination and treatment area. The treatment carried out can be assessed in its spatial context, and this avoids the risk that a monitoring recording by chance displays only that area in which the treatment was carried out faultlessly, while faults in other areas which can lead to subsequent inflammations or the like remain undetected.

In addition, it is possible for the control and/or processing device to combine image data from various imaging equipment and optionally for positional images to be created therefrom. For example, OCT images and IVUS images, as well as images from non-catheter-based imaging methods such as X-ray images or else images from the field of molecular imaging or magnetic-resonance images can in this way be combined or used for segmentation into substantively coherent areas or for recording. The quality of image representation can in this way be further improved.

The handpiece of the dental tool can be fashioned so as to be adaptable to the examination and/or treatment area and/or replaceable. Thus, for example, depending on the type of examination to be carried out, i.e. depending on whether the examination concerned is one in the area of the tooth canals or whether it is an examination in another area of the tooth such as the crown, the handpiece can be modifiable, e.g. by screwing in an additional handle element, or a replacement can be possible. In addition, an adaptation is conceivable such that treatment in other areas of the body, for example in the area of the nose or of the ear, becomes possible. To this end, the length or the diameter of the handpiece, for example, can be modifiable by adding or removing detachable components, or different handpieces can be used from the outset which are adapted to tools fashioned optionally differently. Thus, based upon the treatment tool, it is possible to obtain optimum imaging even in the case of treatments in other areas, or optimum imaging to suit the treatment to be carried out in each case.

The inventive examination and/or treatment tool can comprise a temperature sensor for determining the temperature in the examination and/or treatment area, in particular a temperature sensor arranged in the area of a tip of the imaging catheter or of the tool. Thus, for example, in the case of a drilling tool, a check can be carried out to establish whether a considerable or totally unacceptable rise in temperature occurs in the area of the tooth or the surrounding area. This is particularly appropriate if the patient is under local anesthesia or if a nerve has already been removed so the patient does not notice a possibly excessively high temperature, which can cause long-term damage to the tooth or to the surrounding tissue.

To reduce the size of the tool still further, nanotechnology methods can also be used, for example with regard to a possible coating for protecting the tool or for preventing damage in the treatment area.

In addition, the invention relates to a method for recording image data in a dental examination and/or treatment with a dental examination and/or treatment tool which comprises at least one lumen in which at least one imaging catheter for recording image data of an examination and/or treatment area is or can be accommodated, the imaging catheter of the tool being introduced into the examination and/or treatment area for the continuous and/or temporary recording of image data. Consequently, according to the invention, in an examination or treatment an image data recording is carried out which is based on images of an imaging catheter such as an OCT catheter or an IVUS catheter. In this image data recording, a tool comprising such a catheter, as has been described hereinabove, is introduced at least temporarily into the examination and/or treatment area in order to record image data there at intervals or continuously. The tool can for example be a drilling tool or a tool for cleaning a root canal or such like.

In particular, the method for image data recording can be carried out in a root treatment for a tooth, in which treatment the imaging catheter for image data recording is introduced into the root canal of the tooth and/or into the crown area.

The imaging catheter can be introduced for recording image data of pulp remaining in the root canal after a partial removal of pulp and/or image data of the condition of the tooth and/or of the remaining nerve tissue and/or of a root canal cleaning and/or enlargement and/or shaping and/or of a medication.

So, in a root treatment for example, firstly an opening is made in the crown of the tooth in order to expose the tooth pulp. Then a first layer of the pulp is generally removed, for which a special flexible drill is used which is small enough to be introduced into the root canal. Then the imaging catheter, for example an OCT catheter, is introduced into the root canal or root canals in order to record image data of the remaining pulp and in this way to give the dentist image information with regard to any possible infection and with regard to cracks and fissures in the tooth. In addition, the thickness of the pulp and the remaining nerve tissue can be assessed using the image data. As a catheter optionally of a short design in comparison to catheters to be introduced into vessels, the imaging catheter can to this end have a total length of approximately 2 meters. The catheter can optionally be fashioned with a greater rigidity as an OCT catheter for use, for example, in imaging in the coronary field. In particular, the OCT catheter or another imaging catheter can be accommodated in a lumen of a drilling tool. However, an arrangement in a different tool, for example for follow-up work on the drilled area, is also possible.

Then, in root treatment, the pulp is removed, the root canals are cleaned, enlarged and optionally shaped for later filling. Thereafter, the imaging catheter can be reintroduced into the root canal in order to display the result of the cleaning and shaping and to provide information about possible cracks or fissures and the depth of the root canal. Optionally, this re-introduced imaging catheter can be accommodated in a different tool from that used for the original catheter. Then the interior of the tooth, together with the root canal, is optionally subjected to medicinal treatment in order to kill pathogens and to prevent an infection. The arrangement or spread of the medication in the tooth area is checked upon reintroduction of the imaging catheter, which can also optionally have remained in the root canal during medication.

As a rule, the crown of the tooth is provided with a temporary filling in order to protect the tooth until the next visit to the dentist. The inner cavity in which the pulp was located and the root canal are optionally filled and sealed.

In a subsequent visit to the dentist, the temporary filling is removed and the pulp cavity and the root canals are again cleaned and filled. Finally, a gold or porcelain crown or another type of permanent crown is put in place, and the crown of the tooth is suitably restored.

Depending on the specific embodiment of the method, some of the above steps can be omitted or carried out in a different order and/or slightly changed.

### BRIEF DESCRIPTION OF THE DRAWINGS

Further advantages and details of the invention will emerge from the exemplary embodiments below and from the drawings, in which:

FIG. 1 shows an inventive dental tool comprising an OCT catheter,

FIG. 2 shows an inventive dental tool comprising an OCT and IVUS sensor,

FIG. 3 shows a diagrammatic sketch on the use of a dental tool with a handpiece,

FIG. 4 shows a tool console for a dental tool according to the invention,

FIG. 5 shows an overview regarding image data recording with the tool shown in FIG. 4 and

FIG. 6 shows the procedure for three-dimensional data reconstruction using a position sensor system.

### DETAILED DESCRIPTION OF THE INVENTION

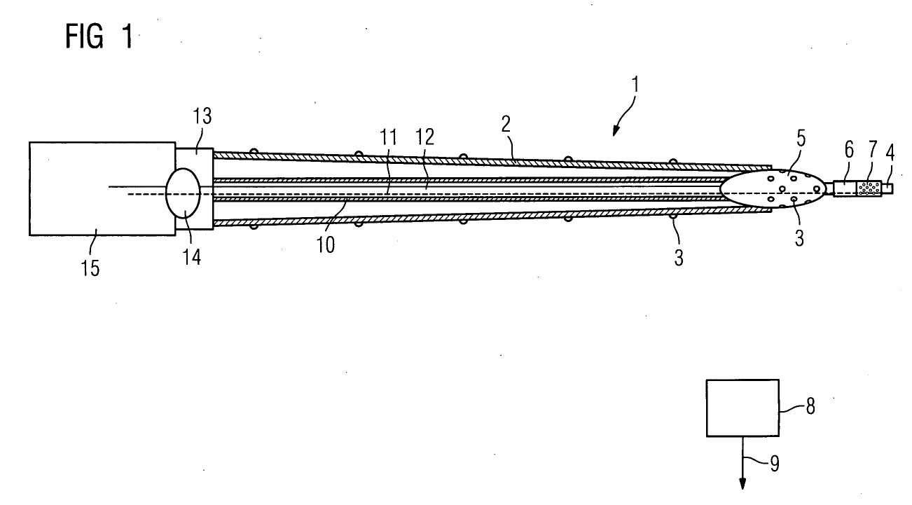

FIG. 1 shows an inventive dental tool 1 comprising an OCT catheter. The tool 1 is a drilling tool which has various cutting elements 3 on its surface 2 for carrying out the treatment. In a root treatment, for example, the pulp can be removed with the tool 1.

The surface 2 of the tool 1 consists in part of a transparent material through which the light of an OCT sensor 4, which is represented here by the tip 5 of the tool 1, can emerge. The OCT sensor 4 is fashioned as a revolving mirror in order to emit or reflect light in different directions. In an alternative embodiment, the OCT sensor can be fashioned as a glass-fiber line which rotates. Rotation in a glass-fiber tube is also possible. For imaging, the OCT sensor 4 makes use of the principle of the Michelson interferometer. The tip 5 of the tool 1 is equipped with an aperture, not shown here, through which the OCT imaging sensor 4 can be guided in order to generate image recordings. A transparent window 6 is provided at the front, through which the light signals of the OCT catheter can emerge and be picked up again.

In addition, the tool 1 has a position sensor system comprising position sensors or detectors 7 arranged in the front area of the tool 1, which sensors or detectors for position determining purposes are connected to external position sensors or detectors 8 outside the body of the patient. There is a connection 9 from the external position sensors or detectors 8 to an interface of a position-determining device.

For deployment in root treatments and the like, the tool 1 has a lumen 10 in which the signal lines 11 of the position sensors or detectors 7 are guided. Besides these, the signal lines 12 of the OCT sensor 4 are accommodated in the lumen 10.

In the rear end area of the tool 1, a mechanical connection system 13 with a rotational coupling 14 is shown. Connected thereto is a combined signal interface and motor unit 15 which serves to forward and receive the image signals of the OCT sensor and via which the drive of the OCT catheter is controlled. The OCT catheter or sensor 4 is rotated or moved forward or backward in a longitudinal direction. In this way, in conjunction with the systems of position sensors or detectors 7 and 8, it is possible to generate three-dimensional reconstructional images by advancing or retracting the imaging catheter.

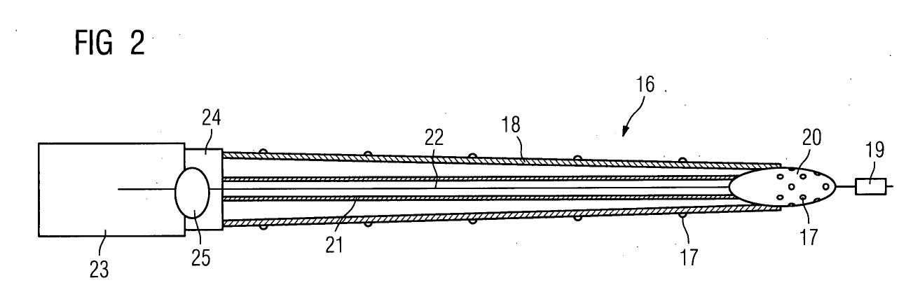

A further dental tool 16 according to the invention is shown in FIG. 2. The tool 16 is also a drill with cutting elements 17 on the surface 18. The surface 18 has transparent windows, which are not shown here, through which the infrared light of an OCT sensor, which is not shown in detail here, can emerge. In addition, the tool 16 has an IVUS sensor 19 for generating images by means of ultrasound. The combination of the OCT sensor and the IVUS sensor 19 enables optimal image generation in different imaging areas. In this way, high-quality image recordings can be produced both in the near field and in the far field. The tip 20 of the tool 16 has an aperture through which the OCT sensor can be guided in order to generate in different areas in front of or behind the tip 20 of the drilling tool 16 image recordings which can be analyzed as the examination proceeds.

The signal lines 22 which lead to the OCT sensor and to the IVUS sensor 19 or which forward data recorded by the respective sensors to a signal interface and motor unit 23 are accommodated in a lumen 21. A mechanical connection system 24 with a rotational coupling 25 enables the execution of rotary movements in order, for example, to rotate the OCT sensor and the IVUS sensor 19, optionally independently of the OCT sensor, at a defined speed. Simultaneously, the OCT catheter or the IVUS catheter can be advanced or retracted automatically or manually in order to monitor the treatment through image recordings in different areas continuously or at defined intervals.

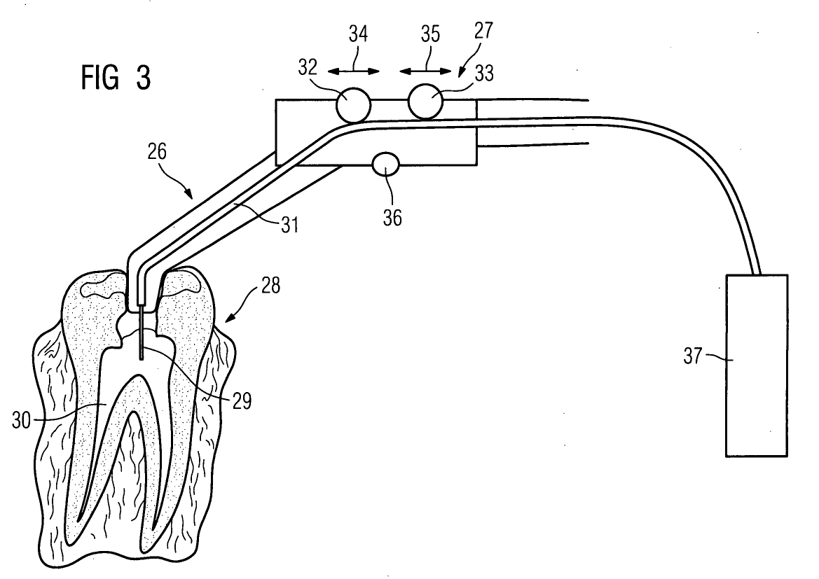

FIG. 3 shows a diagrammatic sketch regarding the use of a dental tool 26 comprising a handpiece 27. The tool 26 is partially introduced into the tooth 28 in order to carry out the treatment, for which purpose an OCT sensor fiber 29 is fashioned appropriately rigidly so as to be able to be introduced into a hollow cavity 30 of the tooth 28. A lumen 31 for the OCT sensor fiber 29 can be moved forward and backward, in the same way that the OCT sensor fiber 29 can be moved several millimeters forward or backward in a longitudinal direction in order to track the course of the treatment and to record image data of the entire examination and treatment area. For this purpose, an actuating element 32 coupled with the OCT sensor fiber 29 is provided, by means of which actuating element the OCT sensor fiber 29 can be moved several millimeters in a longitudinal direction. A second actuating element 33 which is also movably fashioned, as shown here by the arrows 34 and 35, enables movement of the lumen 31, which can also be displaced by a few millimeters.

The actuating element 36 is fashioned as a switch and serves to start or terminate a rotational movement of the OCT sensor fiber 29. Moreover, the speed of rotation of the OCT sensor fiber can be changed with the actuating element 36 by means of multiple actuation. The handpiece 27 has a length in the region of 20 cm.

The OCT generator and analyzer 37 generates the signals which are routed to the tip of the dental tool 26 for imaging and analyzes the recorded data which arrives via the signal lines. The OCT catheter has an overall length from the tip to the OCT generator and analyzer 37 of in the region of a meter.

Thus, using the tool 26 according to the invention, imaging throughout examination and treatment is possible, which imaging can be controlled in a defined manner via actuating elements 32, 33 and 36.

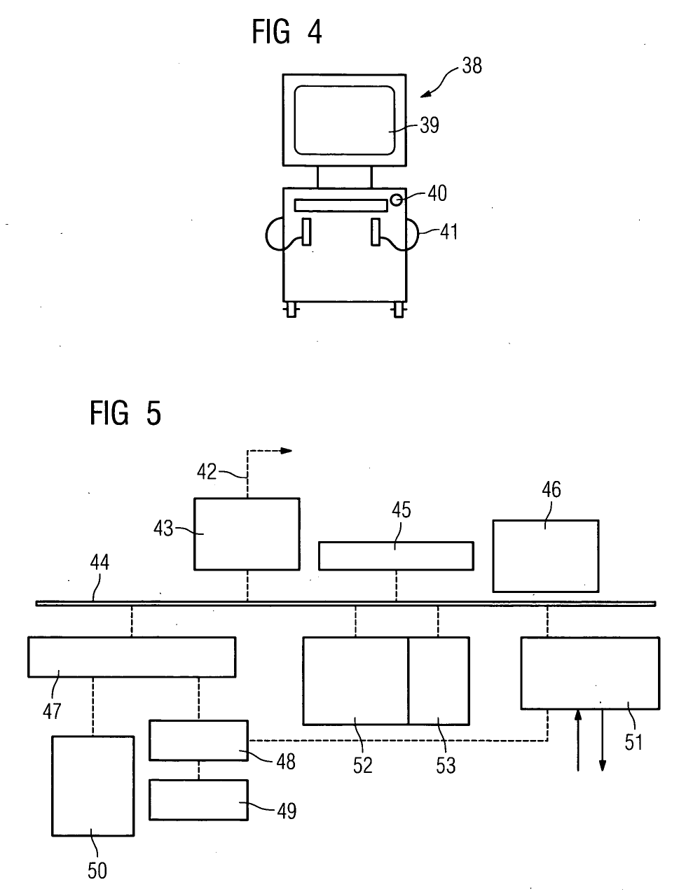

FIGS. 4 and 5 show a tool console 38 and an overview regarding image data recording by means of a tool according to the invention. The movable tool console 38 shown in FIG. 4, which is supported on rollers, is provided for this purpose. This console has a display 39 and an input device 40 on which a user can enter inputs for controlling the tool or the imaging catheter. This is effected via key inputs in combination with a mouse control.

Also shown is a handpiece applicator 41 for connecting to a tool, not shown here, with the facility for imaging by means of optical coherence tomography. The handpiece applicator 41 is, as shown here by the arrow 42 in FIG. 5, connected to an image processing unit 43 which generates the OCT signals and analyzes the recorded image data. The data of the image processing unit 43 is routed to a data bus 44 to which the system control 45 is also connected. Alongside this, a central power supply unit 46 is provided. An image and data memory 48 is connected to an image post-processing unit 47, it being possible for the data of one or more treatments filed in the image and data memory 48 to be transferred if required to a CD and DVD burner 49 so that it can be filed in a portable memory for later examinations. Measurement functions 50 such as, for example, diameter or depth of a treatment area are also taken into account in the image processing.

The image and data memory 48 is additionally connected to an interface 51 for patient and image data, via which the data can be exchanged with external systems or further systems in the dentist's practice. Also shown is the display unit 52 with the input device 53. Thus, as shown in FIG. 5, data recording can be carried out by means of the tool console 38 shown in FIG. 4 throughout the examination process, which data recording enables better assessment of the progress of treatment. The recorded image data can, as shown in FIG. 5, be exchanged via the interface 51 for patient and image data for exchanging with further systems, or it can be retrieved from the image and data memory 48 for subsequent retrieval in a follow-up treatment. A previously created CD or DVD has optionally to be inserted for this purpose.

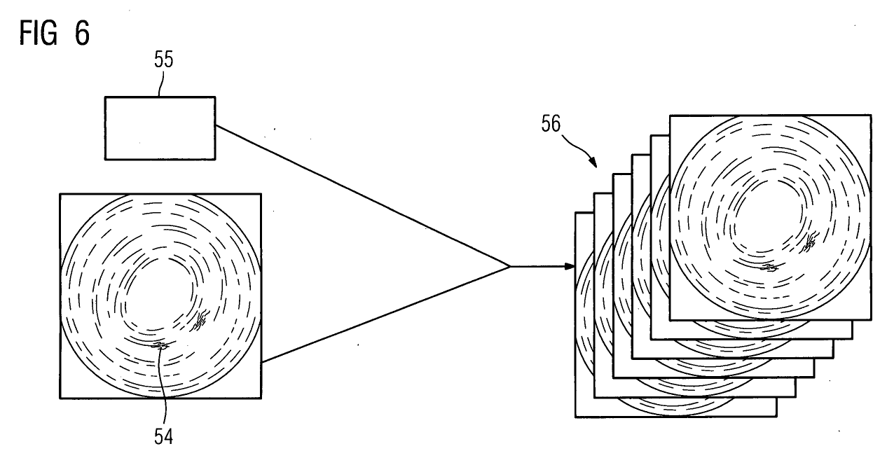

Finally, FIG. 6 shows the procedure for three-dimensional data reconstruction by means of a position sensor system. Here, two-dimensional recordings 54 are firstly created with an OCT imaging catheter, the two-dimensional recording 54 represented here showing inflamed nerve and pulp tissue inside a root canal. The two-dimensional recordings 54 are linked with data 55 from a position sensor system so as ultimately to obtain a three-dimensional dataset 56 in which the area of the root canal in which further drilling or cleaning is optionally to be carried out can be seen in a high-quality image. Further treatment is thus rendered significantly easier for the dentist.

1-14. (canceled)

15. A dental treatment tool, comprising:
a lumen arranged on the dental treatment tool; and
an imaging catheter arranged in the lumen which records image data of an treatment area.

16. The dental treatment tool as claimed in claim 15, wherein the imaging catheter is selected from a group consisting of: an optical coherence tomography catheter, an ultrasound-based catheter, and a magnetic resonance-based catheter.

17. The dental treatment tool as claimed in claim 15, wherein the dental treatment tool comprises a material which is transparent for an imaging signal of the imaging catheter.

18. The dental treatment tool as claimed in claim 15, wherein the dental treatment tool comprises an aperture which is transparent for an imaging signal of the imaging catheter.

19. The dental treatment tool as claimed in claim 15, wherein the imaging catheter is moved via a motor unit.

20. The dental treatment tool as claimed in claim 15, wherein the lumen is moved via a motor unit

21. The dental treatment tool as claimed in claim 15, wherein a hand piece is provided which comprises an actuating element for operating the imaging catheter.

22. The dental treatment tool as claimed in claim 21, wherein the actuating element:
displaces the image catheter along the hand piece,
starts or terminates a rotational movement of a part of the imaging catheter, and
adjusts a rotational speed or displacement speed of the imaging catheter.

23. The dental treatment tool as claimed in claim 21, wherein the actuating element:
displaces the lumen along the hand piece, and
adjusts a displacement speed of the lumen.

24. The dental treatment tool as claimed in claim 21, wherein the handpiece is adaptable to the treatment area or is exchangeable.

25. The dental treatment tool as claimed in claim 15, wherein a position sensor system is provided for determining a position of a part of the imaging catheter in the treatment area.

26. The dental treatment tool as claimed in claim 25, wherein the position sensor system is an electromagnetic operating system and the part of the imaging catheter to be determined is a tip of the imaging catheter.

27. The dental treatment tool as claimed in claim 15, wherein the dental treatment tool comprises a control device for controlling an imaging signal or processing the recorded image data.

28. The dental treatment tool as claimed in claim 27, wherein the control device:
controls the image catheter for recording an image in real time,
displays the image in real time,
reconstructs the recorded image data to three-dimensional, and
mergers the recorded image data with image data from other imaging equipments.

29. The dental treatment tool as claimed in claim 15, wherein a temperature sensor is provided for determining a temperature in the treatment area.

30. The dental treatment tool as claimed in claim 29, wherein the temperature sensor is arranged in an area of a tip of the imaging catheter or the treatment tool.

31. A dental examination tool, comprising:
a lumen arranged on the dental examination tool; and
an imaging catheter arranged in the lumen which records image data of a examination area.

32. A method for recording an image data in a dental treatment area with a dental treatment tool, comprising:
arranging a lumen on the dental treatment tool;
arranging an imaging catheter in the lumen; and
inserting the imaging catheter into the treatment area for recording an image data of the treatment area.

33. The method as claimed in claim 32, wherein the dental treatment is a root treatment of a tooth and the imaging catheter is introduced into a root canal area or a crown area of the tooth.

34. The method as claimed in claim 33, wherein the imaging catheter is introduced for recording an image data selected from the group consisting of: remaining pulp in the root canal after a partial removal of the pulp, tooth condition, remaining nerve tissue, root canal cleaning, root canal enlargement, root canal shaping, and medication spread in the tooth.
